(19) United States
(12) Patent Application Publication
(10) Pub. No.: US 2003/0203675 A1
(43) Pub. Date: Oct. 30, 2003

(54) Apparatus and method for shielding connectors

(75) Inventor: Allan P. McDougall, Monrovia, CA (US)

Correspondence Address: Lerner, David, Littenberg,, Krumholz & Mentlik, LLP, 600 South Avenue West, Westfield, NJ, 07090, US

(73) Assignee: GNP Computers, Inc., Monrovia, CA

(21) Appl. No.: 10/135,974

(22) Filed: Apr. 30, 2002

(51) Int. Cl. H01R 13/648

(52) U.S. Cl. 439/607

(57) ABSTRACT

An Electromagnetic Interference/Radio Frequency Interference (EMI/RFI) shielding plug insert for a modular connector jack is disclosed. The modular connector jack can be shielded with electrically conductive walls. It has metal contacts for transmitting or receiving data. One or more spring contacts protrude inside the modular connector jack from the walls and outside the modular connector jack. A shielded plug made of electrically conductive material is inserted into the connector jack such that the shielded plug comes into contact with the spring contact. Thus, the shielding plug and the connector jack are electrically connected and at the same electrical potential. Thus, the shielded plug provides interference shielding for unused connector jacks.

### BACKGROUND OF THE INVENTION

The invention generally relates to modular connector jacks.

Connectors, including modular connector jacks, are used extensively in electronic equipment. In many cases, it is desirable to use modular connector jacks primarily due to the economy, convenience and standard features they offer. Modular connector jacks, however, generally have a plurality of electrical data conductors, and those conductors are exposed through an aperture in the conductor jack. These exposed electrical data conductors leave electronic systems in which the modular connector jacks are employed susceptible to conducted and radiated electromagnetic interference (EMI) and other interference problems.

These interference problems have resulted in the generation of conducted and radiated emission specifications. These specifications are applicable to most commercial electronic equipment, and they exist in most countries. For example, in the United States there are FCC regulations, in Europe there are EC and VDE regulations to comply with, and in Japan there are VCCI regulations to comply with. All are based on CISPR 22, and there is very little variation on the emission limits that equipment manufacturers must meet. Consequently, conducted and radiated emissions and the resulting EMI are problems that most electronic equipment manufacturers must contend with.

Modern telecommunications equipment frequently use shielded modular connector jacks. These shielded modular connector jacks have an electrically conductive skin, usually made of a thin metal, that helps shield the connector from EMI and other interference. Many times only some of the modular connector jacks provided on the telecommunications equipment are used in a particular application, leaving the shielded modular connector jacks with an open aperture, and susceptible to the previously described interference problems.

Thus, new apparatus and methods to protect unused modular connector jacks from interference problems are needed.

### SUMMARY OF THE INVENTION

In one aspect of the present invention, a connector apparatus includes a receptacle having an opening and a plug that fits into the opening so as to cover the opening. The plug is preferably constructed from an electrically conductive material, and also has no data connections, and therefore no interface with the data connectors in the receptacle. Further, the plug has no cables extending from it.

The plug is preferably constructed with an electrically conductive face and two electrically conductive side walls extending from the face of the plug. The side walls of the plug preferably fit just inside the opening of the connector receptacle, and the face of the plug preferably covers the opening of the connector receptacle, thereby sealing the opening of the connector receptacle from electromagnetic interference and other sources of interference.

A latch is preferably provided on the plug, and a ledge is preferably provided inside the receptacle. In accordance with a preferred embodiment of the present invention, when the plug is inserted into the opening of the receptacle, the latch engages the ledge to hold the plug in place. When it is desired to remove the plug from the receptacle, the latch is depressed with the finger, and the plug easily slides out of the connector receptacle.

### BRIEF DESCRIPTION OF THE DRAWINGS

A more complete appreciation of the present invention and many of the attendant advantages thereof will be readily understood by reference to the following detailed description when considered in connection with the accompanying drawings in which:

FIG. 1 is an isometric view of a shielded modular connector jack with a shielded plug in accordance with one embodiment of the invention;

FIG. 2 is a side view of the shielded modular connector plug;

FIG. 3 is a top view of the shielded modular connector plug;

FIGS. 4 to 10 are front views of standard modular connector jack mechanical keying options; and

FIG. 11 is a computing or telecommunications device having plugs installed in unused modular connector jacks in accordance with one aspect of the present invention.

### DETAILED DESCRIPTION OF THE PREFERRED EMBODIMENT

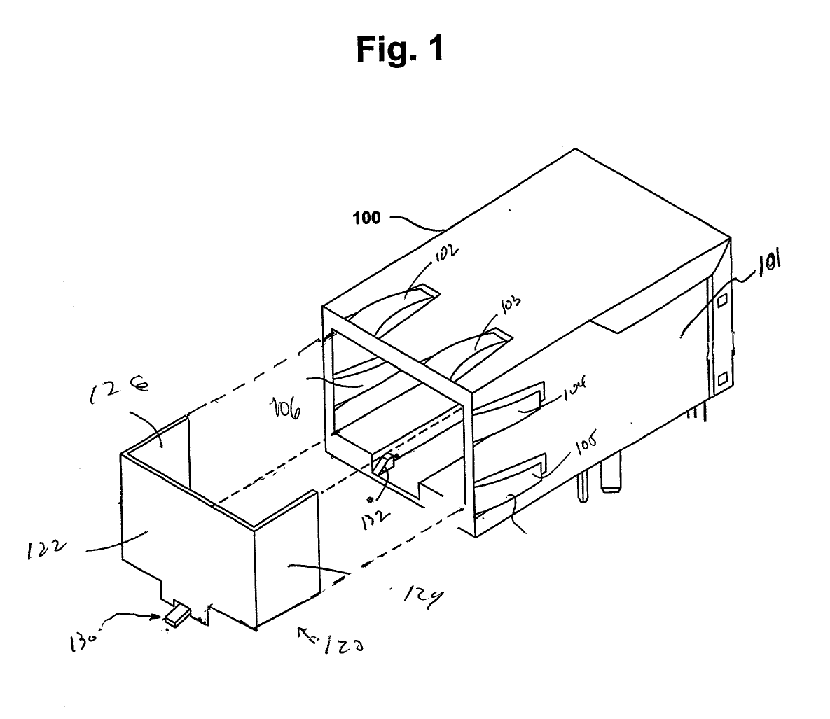

In FIG. 1, a shielded modular connector jack 100 is illustrated. Modular connector jacks are used in many applications. They are generally constructed with plastic bodies that house electrical connectors for providing an electrical data interface. When used to provide a data connection, a male-end connector having internal electrical data connectors and a cable that is connected to the data connectors is inserted into the modular connector jack 100.

The plastic bodies of the modular connector jacks 100 have an opening that provides a connector receptacle for the male-end connector. Internal electrical data connectors are provided inside the opening. Modular connector jacks 100 are available in shielded and unshielded configurations. When unshielded, the modular connector jack 100 is used without anything surrounding its plastic body. In some cases, however, it is desired to shield the modular connector jack 100 to provide some protection from interference problems. In the shielded configuration, generally a thin sheet of metal is provided around the plastic body of the modular connector jack 101.

Today, there are many modular connector jacks available, both in the shielded and unshielded configurations. See, for example, the Series 63, 64, 70 and 65 PC-Mount, modular jacks available from Stewart Connector Systems, Inc., and currently viewable at www.stewartconnector.com.

In the shielded configuration, the modular connector jack 100 generally includes some type of grounding contacts. Referring to FIG. 1, a plurality of spring contacts 102 to 105 extend outward from the surface of the shielded modular connector jack 100. These spring contacts 102 to 105 are generally simply cutouts from the thin metal skin that surrounds the modular connector jack 100, and which are biased outward. There can be other spring contacts extending outward from other walls of the modular connector jack 100 that are not illustrated in FIG. 1. As will be discussed later and as known in the art, these spring contacts 102 to 105 are meant to provide electrical contact with the electronic box in which the modular connector jack 100 is configured. This typically provides a grounding of the modular connector jack 100 to the electronic box, and thereby improves interference protection.

It is also preferred to have spring contacts that protrude inside the opening in the modular connector jack 100. In FIG. 1, a spring contact 106 is illustrated extending inward into a cavity inside the modular connector jack 100. Generally, there is another spring contact extending into the cavity inside the modular connector jack 100 on the opposite inner wall. These internal spring contacts 106 can be formed by a tab from the thin metal skin that surrounds the modular connector jack 100, where the tab is folded inside the cavity. These internal spring contacts 106 engage shields provided on cabled, shielded male-end connectors when they are inserted into the shielded modular connector jack 100 to provide a data interface over the cable that is connected to the modular plug. An example of such a shielded modular connector is the 36 Series modular plugs available from Stewart Connector Systems, Inc.

In accordance with the present invention, a shielded plug 120 is provided to be inserted into the modular connector jack 100 when the modular connector jack 100 is not being used to provide an electrical data connection. The plug 120 is preferably sized to substantially cover the opening in the modular connector jack 100. In accordance with a preferred embodiment, the plug 120 has an external face member 122, a side wall member 124, and another side wall member 126. The plug 120, including the face member 122, the side wall 124, and the second side wall 126 are preferably made from an electrically conductive material. Alternately, the plug 120 can be manufactured with a material such as plastic, and covered with an electrically conductive material. For example, without limiting the generality of the previous statements, the face member 122 and the side walls 124 and 126 can be made from or covered with any of the following materials: metals, electrically conductive plastics, electrically conductive plated or clad plastics, electrically conductive elastomers and elastomeric materials with an electrically conductive surface or mesh. The shielded plug 120 has no electrical data connectors, and provides no electrical data connection to anything. Also, there are no cables extending from the plug 120.

When the shielded modular connector jack 100 is not in use, it is preferred to install or insert the plug 120 into the receptacle. When doing so, the side walls 124 and 126 of the plug 120 preferably fit snugly inside the inner walls of the modular connector jack 100. The side walls 124 and 126, therefore, come into contact with the spring contacts from the modular connector jack 100 that extend into the connector receptacle portion of the jack 100. This contact between the inwardly biased spring contacts 106 and the side walls 124 and 126 of the plug 120, place the plug 120 and the shielded modular connector jack 100 at the same potential, which is usually ground. This grounding configuration provides improved protection from interference.

The face member 122 is preferably sized to cover substantially all of the opening in the modular connector jack 100. It is preferred that the fit between the face member 122 and the opening be very close and tight so that the opening is covered. In an alternative embodiment of the present invention, the face member 122 can be configured to completely cover the opening in the modular connector jack 100. For example, this can be accomplished by extending the face member 122 in all directions so that a lip is provided. The lip, which would overlap the sidewalls 124 and 126, would entirely cover the opening in the jack 100 when the sidewalls 124 and 126 of the shielded plug 120 are inserted into the receptacle of the jack 100.

In accordance with the preferred embodiment of the present invention, a latching mechanism 130 is provided. The latching mechanism 130 on the plug 120 engages a ledge 132 on the modular connector jack 100 when the plug 120 is inserted into the jack 100.

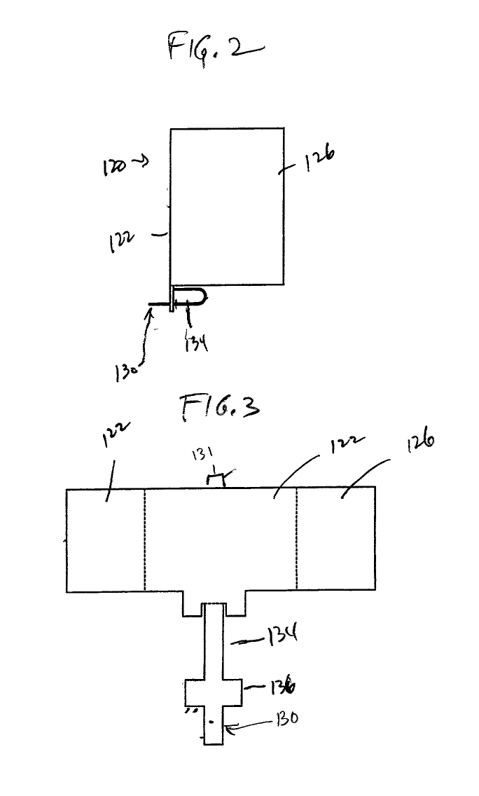

The latching mechanism 130 is illustrated in greater detail in FIGS. 2 and 3. FIG. 2 is a side view of the shielded plug 120 with the latching mechanism 130. FIG. 3 shows the shielded plug 120 in a folded-out flat representation. The latching mechanism 130 includes a tab 131 which is designed to allow a user's finger to manipulate the latching mechanism when it is desired to pull a plug 120 out of a jack 100. A portion 134 of the latching mechanism 130 extends below the bottom of the sidewall 126, and a tab section 136 is provided on the portion 134. The tab section 136, which is on the bottom of the u-shaped latching mechanism, engages the ledge 132 when the plug 120 is inserted into the jack 100. These latching mechanisms are known in the art. See, for example, the 36 Series modular connectors available from Stewart Connector Systems, Inc.

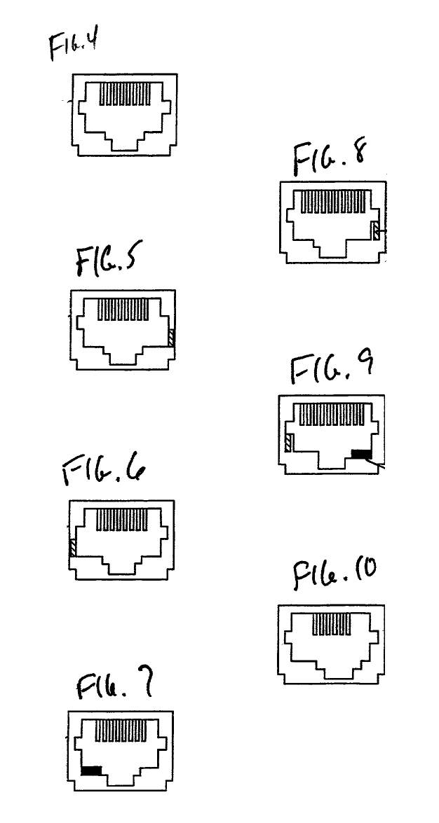

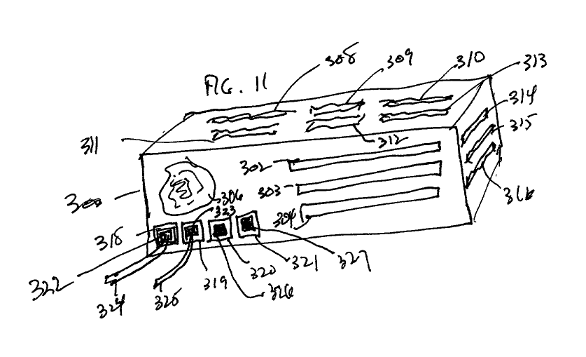

A variety of industry standard keying options for modular connector jacks are illustrated in FIGS. 4-10. FIG. 4 depicts the standard modular connector. FIG. 5 depicts a modular connector jack with K1 keying. FIG. 6 depicts K2 keying. FIG. 7 depicts K4 keying. FIG. 8 depicts RMK keying and FIG. 9 depicts a modular connector jack with RMK4R keying. FIG. 10 depicts a modular connector jack with the OST (MMJ) keying option. In each of the FIGS. 4 to 10, the darkened area represents a filled area, and the cross-hatched area represents a cut out. The present invention can be fabricated to fit any of these standard keying options simply by shaping or keying the plug 120 to fit any key that is provided in the shape of the modular connector jack 100.

FIG. 11 illustrates an electronic box 300. The electronic box 300 has a plurality of circuit boards 302 to 304 installed in it. The box 300 also has a fan 306 to create air circulation for cooling purposes, and vents 308 to 316. The electronic box 300 is representative of boxes used in computing applications and in telecommunications applications, and other electronic applications.

The electronic box 300 also has a plurality of modular connector jacks 318 to 321 mounted in it. The modular connector jacks 318 and 319 each have male-end connectors 322 and 323, respectively, plugged into it to provide a data connection to the circuitry inside the box 300. Each of these connectors 322 and 323 has a cable 324 and 325, respectively, extending from the connector to provide the data connection.

The modular connector jacks 320 and 321 are unused, and in accordance with a preferred embodiment of the present invention, each of the unused modular connector jacks 320 and 321 have shielded plugs 326 and 327, respectively, inserted into their receptacles. As previously discussed, the plugs 326 and 327 have no cables extending from them, have no internal data connectors and provide no electrical data connections to any circuit inside the box 300. The purpose of the shielded plugs 326 and 327 is to protect the box 300 from unwanted and undesirable interference.

As previously explained, the plugs 326 and 327 are preferably grounded to the modular connector jacks 320 and 321, respectively, due to the contact between the spring contacts 106 and the electrically conductive side walls 124 and 126. It is also well known that the modular connector jacks 318 and 321 are preferably grounded to the electronic box 300 generally by the contact between the outwardly biased spring contact on the jack 100 and the frame of the box 300. This grounding arrangement, coupled with the manufacture of the shielded plug 120 with electrically conductive materials, provides maximum shielding from interference.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. Connector apparatus, comprising:
a receptacle having an opening; and
a plug that substantially covers the opening of the connector receptacle, wherein the plug has no electrical data connections.

2. The connector apparatus as claimed in claim 1 wherein the plug has an electrically conductive external face.

3. The connector apparatus as claimed in claim 1 wherein the plug is made from a material selected from the group consisting of: metals, electrically conductive plastics, electrically conductive plated or clad plastics, electrically conductive elastomers and elastomeric materials with an electrically conductive surface or mesh.

4. The connector apparatus as claimed in claim 2, wherein the plug is made from a material selected from the group consisting of: metals, electrically conductive plastics, electrically conductive plated or clad plastics, electrically conductive elastomers and elastomeric materials with an electrically conductive surface or mesh.

5. The connector apparatus as claimed in claim 1, wherein the opening in the receptacle is keyed and the plug is keyed in accordance with the opening.

6. The connector apparatus as claimed in claim 5, wherein the plug fits closely within the opening of the receptacle.

7. The connector apparatus as claimed in claim 1, wherein the plug fits closely within the opening of the receptacle.

8. The connector apparatus as claimed in claim 1, further comprising means for placing the receptacle and the plug at the same electrical potential when the plug is placed inside the opening of the receptacle.

9. The connector apparatus as claimed in claim 1, further comprising means for grounding the receptacle to the plug when the plug is placed inside the opening of the receptacle.

10. The connector apparatus as claimed in claim 3, further comprising one or more spring contacts protruding into the opening of the receptacle, each of the one or more spring contacts being electrically conductive, wherein each of the one or more spring contacts comes in contact with the plug when the plug is placed inside the opening of the receptacle.

11. The connector apparatus as claimed in claim 10, wherein the plug is electrically connected to each of the one or more spring contacts.

12. The connector apparatus as claimed in claim 11, the receptacle having walls that are electrically conductive.

13. The connector apparatus as claimed in claim 1, further comprising a latch on the plug and a ledge in the receptacle, wherein the latch engages the ledge when the plug is inserted into the receptacle.

14. The connector apparatus as claimed in claim 10, further comprising a latch on the plug and a ledge in the receptacle, wherein the latch engages the ledge when the plug is inserted into the receptacle.

15. A method of shielding a receptacle having an opening, comprising the step of inserting a plug having an electrically conductive face and no cable connection into the receptacle.

16. The method as claimed in claim 15, wherein the plug and the receptacle are electrically connected at the same potential when the plug is inserted into the receptacle when the plug is mounted into the receptacle.

17. The method as claimed in claim 15, further comprising the step of inserting the plug into the receptacle until a latch on the plug engages the receptacle to hold the plug in place.

18. A plug for a modular connector jack, the modular connector jack having an opening, comprising:
an electrically conductive face having a shape that substantially covers the opening when the plug is inserted into the modular connector jack;
first and second electrically conductive side walls extending from the electrically conductive face, the first and second electrically conductive side walls being able to fit inside the opening;
a latch connected to the electrically conductive face, the latch being able to engage the modular connector jack when the plug is inserted into the modular connector jack;
wherein there is no cable extending form the electrically conductive face.

19. The plug as claimed in claim 18, wherein the plug is made from a material selected from the group consisting of:
metals, electrically conductive plastics, electrically conductive plated or clad plastics, electrically conductive elastomers and elastomeric materials with an electrically conductive surface or mesh.

20. The plug as claimed in claim 18, wherein the shape of the electrically conductive face completely covers the opening when the plug is inserted into the modular connector jack.

21. Connector apparatus, comprising:
a receptacle having an opening; and
a plug that fits inside the opening of the receptacle, wherein there is no cable extending from the plug.

22. The connector apparatus as claimed in claim 21 wherein the plug has an electrically conductive external face.

23. The connector apparatus as claimed in claim 21 wherein the plug is made from a material selected from the group consisting of: metals, electrically conductive plastics, electrically conductive plated or clad plastics, electrically conductive elastomers and elastomeric materials with an electrically conductive surface or mesh.

24. connector apparatus as claimed in claim 21, wherein the plug is made from a material selected from the group consisting of: metals, electrically conductive plastics, electrically conductive plated or clad plastics, electrically conductive elastomers and elastomeric materials with an electrically conductive surface or mesh.

25. The connector apparatus as claimed in claim 21, wherein the opening in the receptacle is keyed and the plug is keyed in accordance with the opening.

26. The connector apparatus as claimed in claim 25, wherein the plug fits closely within the opening of the receptacle.

27. The connector apparatus as claimed in claim 21, wherein the plug fits closely within the opening of the receptacle.

28. The connector apparatus as claimed in claim 21, further comprising means for placing the receptacle and the plug at the same electrical potential when the plug is placed inside the opening of the receptacle.

29. The connector apparatus as claimed in claim 23, further comprising one or more spring contacts protruding into the opening of the receptacle, each of the one or more spring contacts being electrically conductive, wherein each of the one or more spring contacts comes in contact with the plug when the plug is placed inside the opening of the receptacle.

30. The connector apparatus as claimed in claim 29, wherein the plug is electrically connected to each of the one or more spring contacts.

31. An electronic system, comprising:
an electronic box;
an electronic circuit supported within the electronic box;
a modular connector jack mounted on the electronic box, the modular connector jack providing a data interface with the electronic circuit; and
a shielded plug inserted into the modular connector jack, the shielded plug having no electrical connections to the data interface with the electronic circuit.

32. The electronic system as claims in claim 31, wherein the shielded plug is grounded to the modular connector jack.

33. The electronic system as claimed in claim 32, wherein the modular connector jack is grounded to the electronic box.

34. The electrical system as claimed in claim 32, wherein the shielded plug has no cable attached to it.
